(19) United States
(12) Patent Application Publication
(10) Pub. No.: US 2002/0176973 A1
(43) Pub. Date: Nov. 28, 2002

(54) Laminates including cellulosic materials and processes for making and usng the same

(75) Inventor: LeRoy Herbert Keiser, Darien, IL (US)

Correspondence Address: Monique A Morneault, Wallenstein & Wagner Ltd, 311 South Wacker Drive, 53rd Floor, Chicago, IL, 60606-6630, US

(73) Assignee: Loparex, Inc.

(21) Appl. No.: 09/864,734

(22) Filed: May 23, 2001

(51) Int. Cl. B32B 7/02

(52) U.S. Cl. 428/212; 428/500

(57) ABSTRACT

Laminates including cellulosic material are provided which exhibit dimensional stability upon exposure to changes in ambient moisture. The laminates include at least two layers formed of a cellulosic material sandwiching and bonded to an inner polymeric layer. The polymer layer is thicker than either of the cellulosic layers.

### FIELD OF THE INVENTION

The present invention relates to laminate structures. More particularly, the present invention relates to laminates that include cellulosic materials, which are useful as support substrates in release liners, as well as processes for making the same.

### BACKGROUND OF THE INVENTION

Labels, decals and the like are commonly provided as part of a multi-component system. The multi-component system includes label stock, typically formed of a paper or polymeric film substrate. Print or ornamental designs are often applied to an outer surface of the label stock. The opposing surface of the label stock is coated with an adhesive for adhering the label to a surface. To protect the adhesive coating until use, a release liner overlies and adheres to the adhesive layer.

Commercially available release liners typically include a support substrate, such as a polymeric film or polyolefin coated paper. A release layer is applied to one, or both, surfaces of the support substrate. The release layer can include any of a variety of known release agents, such as fluoropolymers, silicones, and the like.

Many release liner applications require a relatively stiff support substrate. In addition, many applications, such as graphic arts products, require a support substrate that is dimensionally stable and maintains tensile strength at high temperatures. Still further, many applications require a product that is dimensionally stable upon exposure to changes in ambient moisture (or relative humidity) for the best performance.

As an example, signage used on the sides of vehicles, store windows, and the like, is often manufactured from vinyl sheet materials. The vinyl sheets typically have a design element on a surface thereof and an adhesive on the other surface, with a release liner overlying the adhesive. If the release liner is not dimensionally stable upon changes in ambient moisture, temperature, and the like, this can adversely affect the appearance of the signage by affecting color and/or shape registrations.

Polymeric support substrates can be dimensionally stable upon exposure to changes in ambient moisture. However, polymeric substrates typically are not dimensionally stable at elevated temperatures and further can suffer a significant loss of tensile strength at increased temperatures.

Paper is a relatively high modulus material and as such, relatively thick paper stock can provide a support substrate with desirable stiffness properties. Further, conventional polyolefin coated papers are relatively dimensionally stable at high temperatures and maintain tensile properties at elevated temperatures.

Paper substrates, however, typically are not dimensionally stable upon exposure to changes in ambient moisture. As a result, the edges of the paper can curl and/or the substrate as a whole can become wavy. For example, in an environment of high humidity, the paper substrate can absorb water vapor and the liner tends to upcurl. In an environment of low humidity the paper substrate can disorb water vapor and the liner tends to down curl. Thus, the substrate can lose lay flat properties required to maintain the proper alignment of the design elements.

### SUMMARY OF THE INVENTION

The present invention is directed to a laminate that includes cellulosic material yet is substantially dimensionally stable upon exposure to changes in ambient moisture. In particular, the laminate includes outer cellulosic layers sandwiching and bonded to an inner extruded polymeric layer. Preferably the cellulosic layers are paper substrates, such as super-calendered or poly-coated Kraft papers, tissue papers, and the like. The inner polymeric layer can include any of the types of polymers known in the art capable of being melt extruded and preferably is a polyolefin. The resultant laminate can further include release coatings on one, or both, outer surfaces of the cellulosic layers, optionally with polyolefin coatings between the cellulosic layer(s) and the release layer(s).

In the invention, each of the cellulosic layers is thinner than the inner polymer layer. Preferably the polymer provides at least about 45%, and more preferably from about 45% to about 75%, of the total weight of the laminate structure (i.e., the laminate including the outer cellulosic layers and the inner extruded polymeric layer). Yet despite the predominance of the polymeric component, the laminates of the invention can exhibit certain physical properties comparable to that of a single layer cellulosic sheet material having a thickness similar to the thickness of the laminate. In particular, the laminates can exhibit good stiffness, even though a substantial portion of the high modulus cellulosic material is replaced with a polymer. Preferably the laminate exhibits a stiffness value of at least about 75%, or higher, as compared to the stiffness value exhibited by a single cellulosic sheet material having substantially the same thickness as the laminate. This effect can be present even for laminates in which the polymer has a lower modulus relative to the cellulosic material.

Yet, in contrast to conventional cellulosic substrates, the laminates of the invention are substantially dimensionally stable upon exposure to changes in ambient moisture. Thus the invention can minimize or eliminate adverse responses to changes in ambient moisture that are typical of cellulosic substrates without sacrificing stiffness. Further, the laminates of the invention can be less expensive than cellulosic counterparts having the same thickness, in part because of the lower cost of many polymeric materials. Thus, the present invention can also provide a laminate structure with desirable stiffness and lay flat properties at a significant cost reduction.

The laminates of the invention can be prepared by directing first and second cellulosic layers into a surface-to-surface relationship into a laminating nip, while substantially simultaneously extruding a polymer between the cellulosic layers. Alternatively the polymer can be extruded onto a surface of a first cellulosic sheet material and a second cellulosic sheet material thereafter brought into a face-to-face relations with the polymer/cellulosic structure to form the laminate of the invention. The polymer can be extruded as a single layer, or alternatively can be coextruded as two or more polymer layers.

The respective layers of the laminate are bonded to one another without substantial impregnation of the polymer into either of the adjacent cellulosic layers. Indeed, the polymer typically will not impregnate either adjacent cellulosic substrate to any significant degree. This is particularly true for those applications using polyolefin coated cellulosic sheets, super-calendered Kraft paper, and the like. Rather, as the polymeric layer is applied to the cellulosic layer in a molten state, the polymer wets out onto the cellulosic substrate surface and bonds the cellulosic substrates to one another in part due to chemical forces. Adhesion can be enhanced by pretreating the cellulosic layers, for example, using a primer. Despite this structural feature of the laminates of the invention, the resultant laminate can have sufficient adhesion between the various layers so that the laminate fails cohesively rather than delaminates between layers.

The resultant laminate can be directed to additional downstream processing. For example the invention can include the step of applying polyolefin coatings to one or both surfaces of the laminate after the laminate is formed. Alternatively the cellulosic layers may have polyolefin coatings applied to at least one surface thereof prior to extruding the polymeric layer therebetween. The process can also include the step of applying a release coating to one or both outer surfaces of the laminates.

The resultant laminate performs in a manner similar to a cellulosic substrate of comparable thickness with regard to stiffness but provides improved resistance to curl in response to changes in ambient moisture. The resultant laminates are useful for a variety of applications and are particularly useful as a support substrate for a release liner. The properties of dimensional stability and stiffness render the laminates particularly useful as release liners used in the graphic arts industry.

### BRIEF DESCRIPTION OF THE DRAWINGS

Some of the features and advantages of the invention having been described, others will become apparent from the detailed description which follows and from the accompanying drawings, in which:

FIG. 1 is fragmentary top view of one illustrative embodiment of the laminate of the present invention with the respective layers being exposed for clarity of illustration;

FIG. 2 is cross sectional side view of the laminate of FIG. 1;

FIG. 3 is a schematic representation of an exemplary process for making the laminates of the present invention; and

FIG. 4 is a top view of a label formed in accordance with one advantageous embodiment of the present invention, with the top layer peeled away for clarity of illustration.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

FIG. 1 is a fragmentary top view of one embodiment of the laminate of the present invention, designated generally as 10. Laminate 10 includes a first cellulosic layer 12 bonded to a second cellulosic layer 14 by an intermediate polymeric layer 16. The thickness of first and second cellulosic layers 12 and 14 and of polymeric layer 16 can vary, so long as the relative thickness of each of cellulosic layers 12 and 14 is less than the thickness of polymeric layer 16.

The thickness of each of cellulosic layers 12 and 14 can vary from one another, although it can be advantageous in many applications to use cellulosic layers having similar thicknesses. Typically each cellulosic layer independently of the other has a thickness ranging from about 25 micrometers to about 62 micrometers, and preferably from about 32 micrometers to about 45 micrometers. Cellulosic layers 12 and 14 having a thickness outside of these ranges can also be used in accordance with the present invention, so long, as noted above, the thickness of each cellulosic layer 12 and 14 is less than the thickness of polymeric layer 16.

Cellulosic layers 12 and 14 are preferably paper substrates. Any of the types of papers having sufficient tensile strength to be handled in conventional paper coating and treating apparatus can be employed as the substrate layer. The paper used depends upon the end use and particular personal preferences. Examples of the types of paper which can be used include paper, clay coated paper, glassine, polymer coated paper, paperboard from straw, bark, wood, cotton, flax, cornstalks, sugarcane, bagasse, bamboo, hemp, and similar cellulose materials prepared by such processes as the soda, sulfite or sulfate (Kraft) processes, the neutral sulfide cooking process, alkali-chlorine processes, nitric acid processes, semi-chemical processes, etc. Although paper of any weight can be employed as a substrate material, paper having basis weights ranging from about 13 to about 41 grams per square meter (gsm), and preferably from about 19 to about 30 gsm, may be used.

The thickness of the polymeric layer 16 can also vary. The thickness of polymer layer 16 typically ranges from about 62 micrometers to about 125 micrometers, and preferably from about 85 micrometers to about 115 micrometers. Again, however, the polymeric layer can have a thickness falling outside of this range so long as the polymer layer 16 is thicker than either of the cellulosic layers 12 and 14.

Polymer layer 16 can include a single layer of a polymer or multiple layers of polymer, having the same or different compositions. For example, polymer layer 16 can include two or more polymers that are coextruded or alternatively extruded in sequence. Alternatively, at least one, or both, of the cellulosic substrates can be a polymer coated substrate, positioned so that at least one, or both, polymer coatings thereof are adjacent polymer layer 16. In this embodiment, the polymer coating(s) of the respective cellulosic layers can contribute to the overall thickness of polymer layer 16.

Polymer layer 16 can be formed of any of the types of polymeric resins known in the art to be useful in extrusion coating or laminating. Particularly preferred are olefinic polymers, but the invention is not so limited and other polymers can be used as well.

Exemplary olefinic resins useful in the present invention include those formed of alpha-olefins having a carbon number ranging from about 2 to about 10. Examples of such olefinic polymers include ethylene homopolymers, copolymers, and terpolymers, such as high density polyethylene, low density polyethylene, and linear low density polyethylene; propylene homopolymers; polymethylpentene homopolymers; and copolymers, terpolymers, and blends thereof.

The polymeric layer may also be formed of a metallocene, or single site, resin also as known in the art. The metallocene polymer can impart high tear strength properties to the laminate. The metallocene catalyst resin typically is a thermoplastic olefin-based resin, preferably polyethylene, formed using metallocene polymerization catalysis. Metallocene catalyst polyethylene can be characterized by controlled geometry, such as substantially precise placement of a comonomer into the ethylene backbone. Various alpha-olefins are typically copolymerized with ethylene in producing metallocene resins, including higher alpha-olefins such as butene, hexene, 4-methyl-1-pentene, and octene. The comonomer is typically present in an amount of less than about 20% by weight. Examples of suitable commercially available metallocene catalyst polymers include the EXACT polymers available from the Exxon Chemical Company (ranging in densities from about 0.80 to about 0.920 g/cc); the Affinity polymers available from the Dow Chemical Company (ranging in densities from about 0.80 to about 0.920 g/cc); and the Engage resins from DuPont/Dow Elastomers (ranging in densities from about 0.80 to about 0.910 g/cc).

Other polymeric resins useful in the invention include without limitation polyesters, such as polyethylene terephthalate, polybutylene terephthalate, and the like; polyamides, such as polyhexamethylene adipamide, polycaproamide, and the like; polyurethanes; as well as co- and ter-polymers of the same. The polymeric layer can also include thermoplastic elastomers, such as but not limited to, polyurethane elastomers, ethylene-polybutylene copolymers, poly(ethylene-butylene) polystyrene block copolymers, polyadipate esters, polyester elastomeric polymers, polyamide elastomeric polymers, polyetherester elastomeric polymers, ABA triblock or radial block copolymers, such as styrene-butadiene-styrene block copolymers, and the like.

Ionomers as known in the art can also be used in accordance with the present invention in the polymeric layer 16. The term “ionomer” as used herein is defined as a metal-containing ionic copolymer obtained by the reaction between ethylene or an alpha-olefin with an ethylenically unsaturated monocarboxylic acid such as acrylic or methacrylic acid wherein at least 10% of the carboxylic acid groups are neutralized by an alkali metal ion, and having a melting point range of from about 80° C. to 120° C. lonomers are commercially available from E. I. DuPont De Nemours & Company under the name “SURLYN.” Reference is also made to U.S. Pat. No. 3,264,272, which is hereby incorporated by reference in its entirety. This patent describes various types of ionomer resins that may be used in the practice of the present invention.

In addition, blends or mixtures of suitable polymers such as described above can also be used.

When poly coated cellulosic substrates are used, the polymer coating can be any of the types of polymers know to be useful for such applications. Typically such poly coatings are olefinic coatings, and often polyethylene coatings, but the present invention is not so limited.

Various additives, pigments, dispersing aids, adhesion promoters, lubricants, fillers, antioxidants, and the like may be present in the polymeric layer 16. When present, polyolefin coatings on the outer surfaces of the cellulosic substrates can also include suitable additives. For example, a polymer can be blended with fillers such as talc, calcium carbonate, and the like prior to extrusion to form layer 16. Similarly, a polyolefin can be blended with suitable additives(s) prior to extrusion onto at least one surface of a cellulosic substrate, either before or after the laminate is formed. As a non-limiting example, talc filled polypropylene as polymeric layer 16 can provide the added benefit of imparting greater stiffness to the laminate structure.

Paper is a relatively high modulus material and as such can impart desirable stiffness properties to a product. Surprisingly, however, the inventors have found that the laminates of the invention can exhibit good stiffness properties, despite replacing a substantial amount of the high modulus cellulosic material with a polymeric material. This benefit is observed even for those embodiments of the invention in which the cellulosic material is replaced with a lower modulus polymeric material, such as low modulus polyethylene polymers. The invention, however, is not limited to laminates that include a lower modulus polymer material. Laminates in which the polymeric layer 16 is a relatively high modulus polymer, such as polyethylene terephthalate, are also included within the scope of the present invention.

In particular, laminate 10 can exhibit stiffness values of at least about 75%, and higher, as compared to the stiffness value exhibited by a single cellulosic sheet material having substantially the same thickness as the laminate 10. Thus, the laminates of the invention can be useful in applications requiring a particular stiffness value, despite the reduction in the amount of the high modulus cellulosic material.

Further, the laminates of the invention can be less expensive than cellulosic counterparts having the same thickness, in part because of the lower cost of many polymeric materials. Thus, the present invention can also provide a laminate structure with desirable stiffness properties at a significant cost reduction.

The invention also provides flexibility in manufacturing the product and allows production of a product having specifically tailored properties. Several factors can be readily varied, such as: the type, basis weight, thickness and finish of the cellulosic substrate; thickness of the polymer; polymer composition; presence of additives in the polymer; and the like. For example, the relative thicknesses of the cellulosic and polymeric layers can vary depending upon desired stiffness values for the end products, cost parameters, and the like. As another example, the polymer selected as layer 16 can be a relatively low modulus material, such as a polyethylene, for certain applications and a higher modulus material, such as polyester, for other applications. Filler can be added to the polymeric layer to further increase stiffness values.

Although not wishing to be bound by theory or explanation of the invention, the inventors currently believe that the mechanical behavior of laminates can generally be described by reference to I-beam behavior or bending stiffness theory. For example, beam theory has been used to determine that unsymmetrical packaging film laminates can be down-gauged by substituting ionomer resin for more flexible conventional heat sealable resins, such as metallocene polyethylene. However, rather than employing I-beam theory as a tool for down-gauging unsymmetrical film constructions, the present inventors found that a mono- or single sheet formed of a material having a particular, relatively high, bending stiffness, such as paper, can be replaced by laminates comprising thin outer layers of the high flexural modulus material bonded by a relatively thicker layer of a polymeric material, which can have a lower modulus and be less expensive.

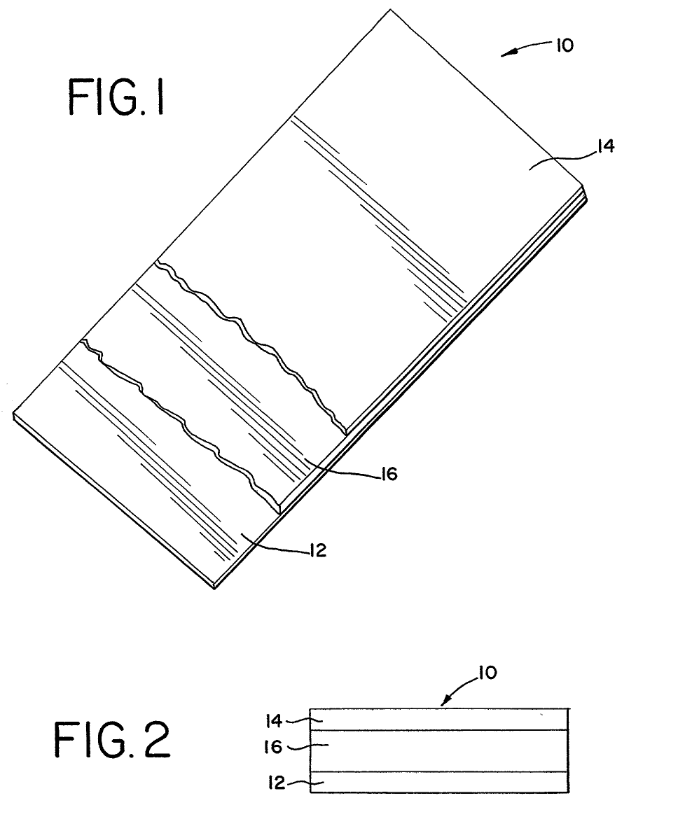

Turning again to FIG. 1, polymeric layer 16 bonds cellulosic layers 12 and 14 to thereby form a unitary multi-layer composite laminate structure 10. As best illustrated in FIG. 2, a cross sectional view of a laminate 10 of the invention, bonding is achieved without substantial complete impregnation of the polymer into either of the adjacent cellulosic layers 12 or 14. Rather, polymeric layer 16 does not impregnate into either adjacent cellulosic layer to any significant degree. Generally, as described in more detail below, the polymeric layer is applied to the cellulosic layer in a molten state and wets out on the cellulosic substrate surface. The molten polymer bonds the cellulosic substrates to one another at least in part due to chemical forces. Adhesion can be enhanced by pretreating the cellulosic layers, also as discussed in more detail below. Despite this structural feature of the laminates of the invention, the resultant laminate can have sufficient adhesion between the various layers so that the laminate fails cohesively rather than delaminate. Stated differently, the laminate can have a destructive bond, i.e., the laminate fails within one of its layers rather than failing between layers. However, the invention is not so limited and can include laminate structures in which the bond between the cellulosic layers and the inner polymeric layer is a weaker bond. In this regard, a weak bond can allow the polymer to behave more like a film and therefore increase tear strength.

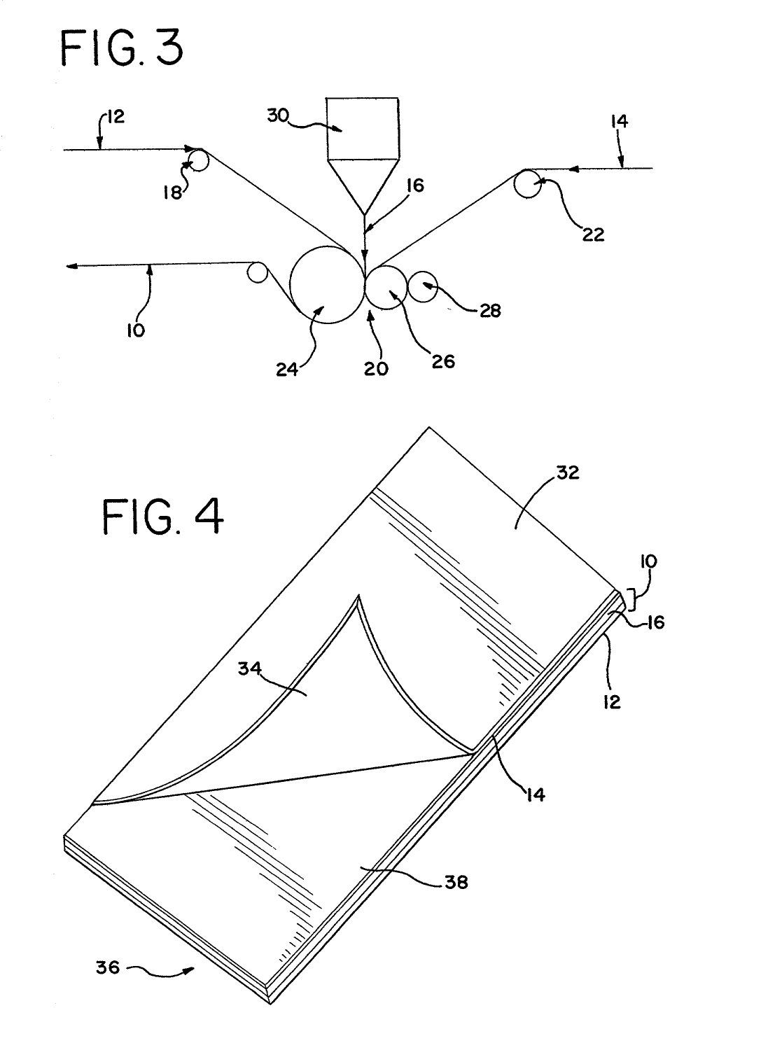

FIG. 3 illustrates an exemplary process for producing the laminates of the present invention. As shown in FIG. 3, a cellulosic layer 12 is directed by a roll 18 to a laminating nip 20 formed by cooperating rotating chill roll 24 and pressure roll 26. A surface of cellulosic layer 12 intended to contact polymeric layer 16 may be activated prior to entering the laminating nip 20 to improve adhesion of the respective layers to one another. Typically, a surface of cellulosic layer 12 is activated in-line immediately prior to entering the laminating nip 20. Alternatively, however, a surface of cellulosic layer 12 can be activated off-line.

The cellulosic substrate surface can be activated using known techniques, for example, corona treatment, chemical priming, chemical etching, ozone injection, flame treatment and the like. For example, a typical chemical priming process includes applying a thin layer of reactive material, such as polyethyleneimine (“PEI”), to the surface of the substrate by methods such as aqueous coating and the like, as is known in the art. Many commercial products are available that include PEI for such applications. Combinations of two or more of surface activation techniques can also be used.

A second cellulosic layer 14 is also directed to the laminating nip 20 by a roll 22. The surface of cellulosic layer 14 contacting polymeric layer 16 can also be activated prior to entering the laminating nip 20. Again, any activation method suitable for use with cellulosic materials, such as those described above with regard to cellulosic layer 12, may be used. Similarly, a surface of cellulosic layer 14 may be activated in-line or offline.

As shown in FIG. 3, a polymeric material is extruded to form a molten polymeric sheet or layer 16. Advantageously, each of cellulosic layers 12 and 14 are directed into a surface-to-surface relationship into nip 20 so that the activated surfaces thereof face one another, while substantially simultaneously extruding the polymer between the cellulosic sheets. However, the invention is not so limited. For example, alternatively, polymeric layer 16 can be extruded onto a surface (advantageously activated) of a cellulosic substrate. Thereafter a second cellulosic sheet material can be directed onto the exposed surface of the molten polymer so as to sandwich the polymer layer between the outer cellulosic layers.

Conventional extrusion conditions and procedures can be used. The specifics of temperature, pressure, line speed, and the like will vary depending upon various factors such as the polymer used, and can be readily determined by the skilled artisan. For example, olefinic polymers, and in particular polyethylenes, can be extruded at temperatures ranging from about 200° C. (392° F.) to about 345° C. (650° F.). The resin is extruded at a rate so that the resultant polymeric layer 16 has a thickness ranging from about 62 micrometers to about 125 micrometers, as discussed above. The weight of the polymeric 16 can vary, and advantageously is selected so that the polymer makes up at least about 45% by weight of the total weight of the laminate (that is, the laminate which includes outer cellulosic layers and inner polymeric layer). Preferably the polymer thickness is selected so that the polymer makes up from about 45% to about 75% by weight of the total weight of the laminate. The extrusion rate from extruder 30 is further coordinated with the running speed of cellulosic layers 12 and 14 which typically ranges from about 50 meters per minute up to about 400 meters per minute.

The resultant structure with outer cellulosic layers 12 and 14 sandwiching inner polymeric 16 is then directed through laminating nip 20. Chill roll 24 can be cooled using conventional techniques, for example by passing a cooling medium (e.g., water) through the interior thereof. The temperature of chill roll 24 is generally maintained from about 15° C. to about 30° C. Temperatures can vary depending upon various factors including the polymer used. Chill roll 24 is typically a cylindrical metal chill roll with a chromium coating applied to the outer surface thereof. The cylindrical roll can be formed of a variety of metals, such as the various steels, aluminum, and the like, as well as alloys thereof. The surface of chill roll 24 is typically smooth, as is known in the art.

The laminating pressure between pressure roll 26 and chill roll 24 is adjusted and maintained by contacting a pressure back-up roll 28 against the pressure roll 26. The pressure roll 26 is typically a rubber covered roll having a Shore A durometer hardness ranging from about 70 to about 95. Other materials having a similar hardness and resiliency as rubber may optionally be used to form the pressure roll 26. The pressure back-up roll 28 urges the pressure roll 26 toward the chill roll 24 and may itself be cooled by passing a cooling medium such as water through the interior thereof. The pressure between the pressure roll 26 and chill roll 24 as applied by the pressure back-up roll 28 generally ranges from about 14 kN/m to about 140 kN/m and preferably ranges from about 17.5 kN/m to about 52.5 kN/m, although again pressures outside these ranges may also be used.

As the structure passes through the laminating nip 20, the polymeric layer solidifies and adheres cellulosic layers 12 and 14 to the polymeric layer to form a coherent structure 10. The resultant laminate can then be directed to a take up roll (not shown) for storage, or alternatively directed downstream for additional processing.

Variations of the extrusion processing conditions will be appreciated by those skilled in the art, such as increasing or decreasing extrusion temperature or web speed, varying the thickness of polymeric layer 16, modification of nip pressure and/or pressure roll hardness, and other process conditions. In addition, polymeric layer 16 can be a coextruded layer formed of at least two or more polymeric layers coextruded using coextrusion equipment and processes also as known in the art.

As another example, the cellulosic substrates may include polyolefin coatings on one or both surfaces thereof prior to extruding polymeric layer 16 therebetween. Alternatively the process of the invention can include the additional step of directing the cellulosic/polymeric/cellulosic laminate exiting nip 20 to a downstream operation to apply a polyolefin coating to one, or both, surfaces of the laminate.

Still further, as discussed in more detail below, one particularly preferred use of the laminates of the invention is as a support substrate for release liners. Thus, the present invention also includes the optional step of applying a suitable release coating to one or both surfaces of the laminate, downstream of the laminating step and optional polyolefin coating step.

FIG. 4 illustrates one useful application for the laminates of the invention. In particular FIG. 4 illustrates a label incorporating a release liner in which the support substrate includes a laminate 10 of the invention. In general, labels are multi-component structures which typically include labelstock 32, an adhesive layer 34 and a release liner 36. Release liner 36 includes a release layer 38 on a surface a laminate 10 as the support substrate. Labelstock 32 may optionally have a design element incorporated therein, for example, as printed indicia on a surface thereof.

Release layer 38 can include any of the types of release agents known in the art which impart release properties to a substrate. For example, the release layer 38 can be a coating of a release agent, such as a fluoropolymer, silicone, chromium complexes of long chain fatty acids, and the like. Typically, such release agents are cured by any of several techniques, including the use of either heat or electromagnetic radiation, such as ultraviolet (UV), electron beam, and the like. Release layer 38 can also be cured by evaporative processes as known in the art, i.e., dried to remove solvent. Exemplary release agents include without limitation SYL-OFF® 294 with Dow Corning 176 Catalyst, commercially available from Dow Coming; UV9315 with UV9310C catalyst, commercially available from General Electric Silicones, and Quilon®, commercially available from E.I. DuPont.

Corona treatment or flame treatment can advantageously be used to promote adhesion of release layer 38 to the surface of laminate 10. Release layer 38 has a thickness sufficient to impart the desired release properties to laminate 10, typically ranging from about 0.02 micrometers to about 1.6 micrometers, although amounts outside this range may also be used.

In use, labelstock 32 and adhesive layer 34 can be readily pulled away and removed from release liner 36, as indicated. The labelstock can then be adhered via adhesive layer 34 to a suitable surface. The labelstock can be supplied in various forms, such as sheet materials, a supply of roll labels, and the like. In addition, labelstock can have a design applied to a surface thereof (for example by printing) or alternatively can be cut or perforated about the perimeter of a design element to allow just the design to be pulled away and removed from the release material.

To make a product such as that illustrated in FIG. 4, an adhesive layer can be applied to the exposed surface of release layer 38 on release liner 36. The adhesive layer/release liner composite structure can thereafter be directed into a face-to-face relationship with a suitable substrate (such as labelstock 32) to form a release liner/adhesive/substrate structure such that the adhesive layer is sandwiched between the substrate and release liner sheet.

The adhesive layer can be formed of various suitable conventional adhesives known in the art, and preferably is a pressure sensitive adhesive. Pressure sensitive adhesives in dry form (substantially solvent free except for residual solvent) are typically aggressively and permanently tacky at room temperature (e.g., from about 15 to about 25° C.) and firmly adhere to a variety of surfaces upon contact without the need for more than manual pressure. Such adhesives typically do not require activation by water, solvent or heat to exert a strong adhesive holding force towards materials such as paper, glass, plastics, wood, and metals. Exemplary pressure sensitive adhesives include rubber-resin materials, polyolefins, acrylics, polyurethanes, polyesters, polyamides, and silicones. The pressure sensitive adhesive may be solvent-coatable, hot-melt coatable, radiation curable (for example, by electron beam or ultraviolet radiation), and water based emulsion type adhesives, all as well known in the art. Specific examples of pressure sensitive adhesives include polyolefin-based polymers and copolymers, such as ethylene vinyl acetate copolymers; acrylic-based adhesives, such as isooctyl acrylate/acrylic acid copolymers and tackified acrylate copolymers; tackified rubber-based adhesives, such as tackified styrene-isoprene-styrene block copolymers, tackified styrene-butadiene-styrene block copolymers and nitrile rubbers, such as acrylonitrilebutadiene; and silicone-based adhesives, such as polysiloxanes.

Adhesive layer 38 can be a single layer of a suitable adhesive material; alternatively, adhesive layer 38 can include multiple layers of adhesive materials. Adhesive layer 38 can also be a substantially continuous or discontinuous layer.

Exemplary substrates useful as labelstock 32 include, without limitation, polymeric substrates, such as polymer films, polymer foams, sheets formed of synthetic staple fibers and/or filaments, and the like; cellulosic substrates, such as paper substrates, woven, knit, netted or nonwoven fabric substrates formed of natural fibers and/or filaments, and the like; substrates including both polymeric and cellulosic components, for example, sheets formed of a blend or mixture of synthetic and cellulosic staple fibers and/or filaments; metal foils; and the like. The substrate can also be a laminate in accordance with the present invention, such as that designated as 10 in FIG. 1.

Advantageously a surface of the labelstock opposite the adhesive layer is rendered receptive to printed indicia using techniques known in the art, such as corona treatment, application of an additional layer to the substrate surface which is receptive to printed indicia, and the like.

Alternatively, the adhesive may be sandwiched between two release liners to form an unsupported adhesive construction.

The present invention will be further described by the following non-limiting examples.

### EXAMPLE 1

Four different laminate constructions are prepared, two with low density polyethylene (LDPE) and two with polypropylene (PP) as the laminating polymeric layer. All four laminates use two layers of a 16 pound per ream (3000 square feet) or 27 grams per square meter paper.

For the LDPE samples, the two layers of paper are laminated with 2 and 2.9 mils (50.8 and 73.7 micrometers, respectively) of LDPE. Both samples are subsequently extrusion coated with about 0.8 mils (21 micrometers) of LDPE on each side. One side of the laminates has a glossy finish and the other has a matte finish.

For the PP samples, the two layers of paper are laminated with 2.6 and 3.1 mils (66 and 78.7 micrometers, respectively) of PP. Both samples are subsequently extrusion coated with about 0.8 mils (21 micrometers) of PP on each side. Again, one side has a glossy finish and the other side has a matte finish.

The samples prepared using PP as the laminating material exhibit higher stiffness values than the samples laminated with LDPE. However, the samples prepared using LDPE still exhibit a desirable degree of stiffness.

### EXAMPLE 2

Two 24.5 gsm (38 micrometers thick) bleached machine glazed high wet strength waxing tissues are laminated together with 83 gsm (89 micrometers) of high density polyethylene. The laminate is subsequently coated with 21.3 gsm of high density polyethylene on each side. One side is a glossy finish and the other side is a matte finish. A silicone coating was applied to the glossy side. The resulting laminate is sufficiently stiff to be used in graphic arts applications in spite of the fact that it is based on only 49 gsm of cellulosic substrate compared to the 100 or 120 gsm cellulosic substrates commonly used to achieve the required stiffness.

### EXAMPLE 3

Two paper substrates, each poly coated on both surfaces thereof, are used in the construction of a laminate in accordance with the present invention. Each substrate includes 21 gsm glossy polyethylene on one surface thereof and about 35 gsm matte polyethylene on the opposite surface. Each paper substrate is itself about a 25 gsm substrate. The two poly coated paper substrates are joined by extruding polyethylene therebetween in an amount sufficient to form about a 12 gsm polyethylene layer. The resultant product includes about 21 gsm glossy polyethylene/about 25 gsm paper/about 82 gsm polyethylene/about 25 gsm matte polyethylene. This embodiment of the invention can provide advantages in the line speeds used to extrude the polymer layer between the paper substrates.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A laminate including cellulosic material exhibiting substantial dimensional stability upon exposure to changes in ambient moisture, comprising:
first and second layers comprising a cellulosic material, each of said first and second layers defining a thickness; and
a layer comprising a polymer disposed between but without substantially completely impregnating either of said cellulosic layers, said polymer layer having a greater thickness than either of the first and second cellulosic layers.

2. The laminate of claim 1, wherein said polymer comprises at least about 45% by weight of the total weight of said laminate.

3. The laminate of claim 2, wherein said polymer comprises from about 45 to about 75% by weight of the total weight of said laminate.

4. The laminate of claim 1, wherein each of said first and second cellulosic layers comprises a paper substrate.

5. The laminate of claim 4, wherein each of said paper substrates has a basis weight ranging from about 13 to about 41 grams per square meter (gsm).

6. The laminate of claim 5, wherein each of said paper substrates has a basis weight ranging from about 19 to about 30 gsm.

7. The laminate of claim 1, wherein said polymer is selected from the group consisting polyolefins, polyesters, polyamides, polyurethanes, thermoplastic elastomers, ionomers, co- and ter-polymers thereof, and blends thereof.

8. The laminate of claim 7, wherein said polymer is a polyolefin.

9. The laminate of claim 8, wherein said polyolefin is a metallocene polyolefin.

10. The laminate of claim 8, wherein said polyolefin is a homopolymer, copolymer or terpolymer of an alpha-olefin having a carbon number ranging from about 2 to about 10.

11. The laminate of claim 10, wherein said polyolefin is selected from the group consisting of high density polyethylene, low density polyethylene, polypropylene, polymethylpentene, and copolymers, terpolymers and mixtures thereof.

12. The laminate of claim 1, wherein said polymer layer has a thickness ranging from about 62 micrometers to about 125 micrometers and each of said cellulosic layers has a thickness ranging from about 25 micrometers to about 62 micrometers.

13. The laminate of claim 12, wherein said polymer layer has a thickness ranging from about 85 micrometers to about 115 micrometers and each of said cellulosic layers has a thickness ranging from about 32 micrometers to about 45 micrometers.

14. The laminate of claim 1, wherein said laminate exhibits at least about 75% of the stiffness value exhibited by a single layer sheet material of said cellulosic material having substantially the same thickness as said laminate.

15. The laminate of claim 1, further comprising at least one polyolefin coating on an exposed surface of the laminate.

16. The laminate of claim 15, further comprising a release layer on an exposed surface of said polyolefin coating.

17. The laminate of claim 15, further comprising polyolefin coatings on both exposed surfaces of the laminate.

18. The laminate of claim 17, further comprising a release layer on an exposed surface of each of said polyolefin coatings.

19. The laminate of claim 1, wherein said polymer has a lower modulus value than said first or second cellulosic layers

20. The laminate of claim 1, wherein said polymer does not substantially penetrate into either of said cellulosic layers.

21. The laminate of claim 1, wherein said polymer layer comprises at least two coextruded polymer layers.

22. The laminate of claim 1, wherein said polymer includes one or more additives.

23. The laminate of claim 22, wherein said additive comprises a filler.

24. The laminate of claim 23, wherein said polymer is polypropylene and said additive is talc.

25. The laminate of claim 22, wherein said additive comprises a pigment.

26. The laminate of claim 15, wherein said at least one polyolefin coating comprises an additive.

27. The laminate of claim 1, wherein the polymer disposed between said cellulosic layers is comprised of more than one polymer layer.

28. The laminate of claim 27, wherein at least one of said polymer layers is an extruded polymer layer, and wherein at least another of said polymer layers comprises a polymer coating on a surface of at least one of said cellulosic layers adjacent said extruded polymer layer.

29. The laminate of claim 28, wherein said polymer further comprises a polymer coating on a surface of the other of said cellulosic layers adjacent said extruded polymer layer.

30. A laminate including cellulosic material exhibiting substantial dimensional stability upon exposure to changes in ambient moisture, comprising:
first and second cellulosic layers, at least one of said cellulosic layers comprising a polymer coating on at least one surface thereof, each of said first and second cellulosic layers further defining a thickness; and
a polymer extruded between but without substantially completely impregnating either of said cellulosic layers, so that the polymer coating of said cellulosic layer is adjacent said extruded polymer layer, wherein the extruded polymer and the polymer coating of the cellulosic layer form a polymer layer having a greater thickness than either of the first and second cellulosic layers.

31. The laminate of claim 30, further comprising a polymer coating on a surface of the other of said cellulosic layers adjacent said extruded polymer layer, wherein the extruded polymer and the polymer coatings of the cellulosic layers form a polymer layer having a greater thickness than either of the first and second cellulosic layer.

32. A method of making a laminate including cellulosic material exhibiting substantial dimensional stability upon exposure to changes in ambient moisture, the method comprising:
extruding a molten polymer onto a surface of a first cellulosic substrate to form a molten polymer layer thereon;
bringing said first cellulosic substrate and a second cellulosic substrate together into opposing surface-to-surface relationship so that said molten polymer layer is sandwiched between and bonds together said first and second cellulosic substrates without substantially completely impregnating either of said cellulosic layers, said polymer layer defining a thickness which is greater than the thickness of either of said cellulosic layers; and
cooling said molten polymer layer to form a coherent laminate structure.

33. The method of claim 32, wherein said extruding step and bringing step occur substantially simultaneously.

34. The method of claim 33, wherein said extruding step and bringing step together comprise directing said first and second cellulosic layers in surface-to-surface relationship into a laminating nip while substantially simultaneously extruding said molten polymer between said cellulosic layers.

35. The method of claim 32, wherein said extruding step comprises coextruding at least two polymers to form a coextruded polymer layer.

36. The method of claim 32, further comprising extruding at least one polyolefin coating on an exposed surface of the laminate.

37. The method of claim 36, further comprising applying a release layer on an exposed surface of said polyolefin coating.

38. The method of claim 36, further comprising extruding polyolefin coatings on both exposed surfaces of the laminate.

39. The method of claim 38, further comprising applying a release layer on an exposed surface of each of said polyolefin coatings.

40. The method of claim 32, wherein said polymer includes an additive.

41. The method of claim 40, wherein said additive comprises a filler.

42. The method of claim 41, wherein said polymer is polypropylene and said additive is talc.

43. The method of claim 40, wherein said additive comprises a pigment.

44. The method of claim 36, wherein said at least one polyolefin coating comprises an additive.

45. The method of claim 32, wherein the polymer disposed between said cellulosic layers is comprised of more than one polymer layer.

46. The method of claim 45, wherein at least one of said cellulosic substrates comprises a polymer coating of a surface thereof and wherein said bringing step comprises bringing said cellulosic substrates together so that the polymer coating is adjacent said extruded polymer and forms a part of the polymer layer having a thickness greater than the thickness of either of said cellulosic layers.

47. The method of claim 46, wherein the other of said cellulosic substrates also comprises a polymer coating of a surface thereof and wherein said bringing step comprises bringing said cellulosic substrates together so that the polymer coatings are adjacent said extruded polymer and form a part of the polymer layer having a thickness greater than the thickness of either of said cellulosic layers

48. A method of making a laminate including cellulosic material exhibiting substantial dimensional stability upon exposure to changes in ambient moisture, the method comprising:
providing a first cellulosic substrate having a polymer coating on at least one surface thereof;
extruding a molten polymer onto said polymer coated surface of said cellulosic substrate to form a molten polymer layer thereon;
bringing said first cellulosic substrate and a second cellulosic substrate also having a polymer coating on a surface thereof together into opposing surface-to-surface relationship so that said molten polymer layer is sandwiched between said polymer coated surfaces of each of said cellulosic substrates and bonds together said first and second cellulosic substrates without substantially completely impregnating either of said cellulosic layers, said polymer coated layers and said extruded polymer layer defining a thickness which is greater than the thickness of either of said cellulosic layers; and
cooling said molten polymer layer to form a coherent laminate structure.

49. A release liner including cellulosic material and exhibiting substantial dimensional stability upon exposure to changes in ambient moisture, comprising:
first and second layers comprising a cellulosic material, each of said first and second layers defining a thickness;
a layer comprising a polymer disposed between but without substantially completely impregnating either of said cellulosic layers, said polymer layer further having a greater thickness than either of the first and second cellulosic layers; and
a release coating on at least one outer surface of said laminate.

50. The release liner of claim 49, wherein said polymer comprises at least about 45% by weight of the total weight of said laminate.

51. The release liner of claim 50, wherein said polymer comprises from about 45 to about 75% by weight of the total weight of said laminate.

52. The release liner of claim 49, wherein each of said first and second cellulosic layers comprises a paper substrate.

53. The release liner of claim 52, wherein each of said paper substrates has a basis weight ranging from about 13 to about 41 grams per square meter (gsm).

54. The release liner of claim 53, wherein each of said paper substrates has a basis weight ranging from about 19 to about 30 gsm.

55. The release liner of claim 49, wherein said polymer is selected from the group consisting polyolefins, polyesters, polyamides, polyurethanes, thermoplastic elastomers, ionomers, co- and ter-polymers thereof, and blends thereof.

56. The release liner of claim 55, wherein said polymer is a polyolefin.

57. The release liner of claim 56, wherein said polyolefin is a metallocene polyolefin.

58. The release liner of claim 56, wherein said polyolefin is a homopolymer, copolymer or terpolymer of an alpha-olefin having a carbon number ranging from about 2 to about 10.

59. The release liner of claim 58, wherein said polyolefin is selected from the group consisting of high density polyethylene, low density polyethylene, polypropylene, polymethylpentene, and copolymers, terpolymers and mixtures thereof.

60. The release liner of claim 49, wherein said polymer layer has a thickness ranging from about 62 micrometers to about 125 micrometers and each of said cellulosic layers has a thickness ranging from about 25 micrometers to about 62 micrometers.

61. The release liner of claim 60, wherein said polymer layer has a thickness ranging from about 85 micrometers to about 115 micrometers and each of said cellulosic layers has a thickness ranging from about 32 micrometers to about 45 micrometers.

62. The release liner of claim 49, wherein said laminate exhibits at least about 75% of the stiffness value exhibited by a single layer sheet material of said cellulosic material having substantially the same thickness as said laminate.

63. The release liner of claim 49, further comprising at least one polyolefin coating disposed between said cellulosic layer and said release layer.

64. The release liner of claim 63, further comprising a second polyolefin coating on a surface of the laminate opposite said release layer.

65. The release liner of claim 64, further comprising a release layer on an exposed surface of said second polyolefin coating.

66. The release liner of claim 49, wherein said polymer has a lower modulus value than said first or second cellulosic layers

67. The release liner of claim 49, wherein said polymer does not substantially penetrate into either of said cellulosic layers.

68. The release liner of claim 49, wherein said polymer layer comprises at least two coextruded polymer layers.

69. The release liner of claim 49, wherein said polymer includes one or more additives.

70. The release liner of claim 69, wherein said additive comprises a filler.

71. The release liner of claim 70, wherein said polymer is polypropylene and said additive is talc.

72. The release liner of claim 69, wherein said additive comprises a pigment.

73. The release liner of claim 63, wherein said at least one polyolefin coating comprises an additive.

74. The release liner of claim 49, wherein the polymer disposed between said cellulosic layers is comprised of more than one polymer layer.

75. The release liner of claim 74, wherein at least one of said polymer layers is an extruded polymer layer, and wherein at least another of said polymer layers comprises a polymer coating on a surface of at least one of said cellulosic layers adjacent said extruded polymer layer.

76. The release liner of claim 75, wherein said polymer further comprises a polymer coating on a surface of the other of said cellulosic layers adjacent said extruded polymer layer.

77. A release liner including cellulosic material exhibiting substantial dimensional stability upon exposure to changes in ambient moisture, comprising:
first and second cellulosic layers, at least one of said cellulosic layers comprising a polymer coating on at least one surface thereof, each of said first and second cellulosic layers further defining a thickness;
a polymer extruded between but without substantially completely impregnating either of said cellulosic layers, so that the polymer coating of said cellulosic layer is adjacent said extruded polymer layer, wherein the extruded polymer and the polymer coating of the cellulosic layer form a polymer layer having a greater thickness than either of the first and second cellulosic layers; and
a release coating on at least one outer surface of said cellulosic layers.

78. The release liner of claim 77, further comprising a polymer coating on a surface of the other of said cellulosic layers adjacent said extruded polymer layer, wherein the extruded polymer and the polymer coatings of the cellulosic layers form a polymer layer having a greater thickness than either of the first and second cellulosic layers.

79. A method of making a release liner including cellulosic material exhibiting substantial dimensional stability upon exposure to changes in ambient moisture, the method comprising:
extruding a molten polymer onto a surface of a first cellulosic substrate to form a molten polymer layer thereon;
bringing said first cellulosic substrate and a second cellulosic substrate together into opposing surface-to-surface relationship so that said molten polymer layer is sandwiched between and bonds together said first and second cellulosic substrates without substantially completely impregnating either of said cellulosic layers, said polymer layer defining a thickness which is greater than the thickness of either of said cellulosic layers;
applying a release coating of a surface of at least one of said cellulosic substrates.

80. The method of claim 79, wherein said extruding step and bringing step occur substantially simultaneously.

81. The method of claim 80, wherein said extruding step and bringing step together comprise directing said first and second cellulosic layers in surface-to-surface relationship into a laminating nip while substantially simultaneously extruding said molten polymer between said cellulosic layers.

82. The method of claim 79, wherein said extruding step comprises coextruding at least two polymers to form a coextruded polymer layer.

83. The method of claim 79, further comprising extruding at least one polyolefin coating on an exposed surface of the laminate prior to applying a release coating, and wherein the step of applying a release coating comprises applying a release coating onto an exposed surface of said polyolefin coating.

84. The method of claim 83, further comprising extruding polyolefin coatings on both exposed surfaces of the laminate prior to applying a release coating, and wherein the step of applying a release coating comprises applying a release coating on an exposed surface of each of said polyolefin coatings.

85. The method of claim 79, wherein said polymer includes one or more additives.

86. The method of claim 85, wherein said additive comprises a filler.

87. The method of claim 86, wherein said polymer is polypropylene and said additive is talc.

88. The method of claim 85, wherein said additive comprises a pigment.

89. The method of claim 83, wherein said at least one polyolefin coating comprises an additive.

90. The method of claim 79, wherein the polymer disposed between said cellulosic layers is comprised of more than one polymer layer.

91. The method of claim 90, wherein at least one of said cellulosic substrates comprises a polymer coating of a surface thereof and wherein said bringing step comprises bringing said cellulosic substrates together so that the polymer coating is adjacent said extruded polymer and forms a part of the polymer layer having a thickness greater than the thickness of either of said cellulosic layers.

92. The method of claim 91, wherein the other of said cellulosic substrates also comprises a polymer coating of a surface thereof and wherein said bringing step comprises bringing said cellulosic substrates together so that the polymer coatings are adjacent said extruded polymer and form a part of the polymer layer having a thickness greater than the thickness of either of said cellulosic layers

93. A method of making a release liner including cellulosic material exhibiting substantial dimensional stability upon exposure to changes in ambient moisture, the method comprising:
providing a cellulosic substrate having a polymer coating on at least one surface thereof;
extruding a molten polymer onto said polymer coated surface of said cellulosic substrate to form a molten polymer layer thereon;
bringing said first cellulosic substrate and a second cellulosic substrate also having a polymer coating on a surface thereof together into opposing surface-to-surface relationship so that said molten polymer layer is sandwiched between said polymer coated surfaces of each of said cellulosic substrates and bonds together said first and second cellulosic substrates without substantially completely impregnating either of said cellulosic layers, said polymer coated layers and said extruded polymer layer defining a thickness which is greater than the thickness of either of said cellulosic layers; and
applying a release coating of a surface of at least one of said cellulosic substrates.
